(19) United States
(12) Patent Application Publication
(10) Pub. No.: US 2018/0373400 A1
(43) Pub. Date: Dec. 27, 2018

(54) User Customizable Alerting for Online Content Stores

(71) Applicant: SAP SE, Walldorf (DE)

(72) Inventor: David Sierro Elvira, Heidelberg (DE)

(21) Appl. No.: 15/630,879

(22) Filed: Jun. 22, 2017

(51) Int. Cl. G06F 3/0482; G06F 17/30

(52) U.S. Cl. CPC G06F 3/0482; G06F 17/2235; G06F 17/30867

(57) ABSTRACT

This document describes user customizable subcategory definition for online content stores, as well as user customizable alerting for changes that occur to objects within the online content stores, particularly as those changes pertain to the defined subcategories. A GUI of a social media application is generated having a set of graphical elements, each representing an object category or an object. Input data is received to define one or more selected sub-categories, which is processed to generate additional graphical elements representing the one or more selected sub-categories. An updated graphical user interface of the social media application is generated, comprising the set graphical elements and the additional graphical elements.

### TECHNICAL FIELD

The subject matter described herein relates to alerts for online content stores, and more particularly to user customizable alerts for online content stores.

### BACKGROUND

Online content stores can be created by various applications or groups, such as cloud based social media platforms like SAP's JAM, which allows employees to collaborate and share documents and ideas around a topic or goal, instead of having to do so through emails and other avenues that are harder to manage and track. Social media platforms and applications such as JAM or SAP's Jumble application, for example, either provide too many notifications to users or too few, or provide information that is not at all interesting to a user. Some applications are difficult and/or time consuming to use, as a user has to access and enter the application very often to check for notifications and updates in topics and/or objects (files, threads, . . . etc.) they are interested in, despite no updates occurring. No alert notifications are currently created, however the categories and subcategories pertaining to such notifications are too expansive.

Currently, there are a predefined number of categories and subcategories set for such applications and online content stores. The structure of the category and subcategory items is conventionally created by an administrator, and there are many details that cannot be filtered. By way of example, and as shown in FIG. 1, when a user accesses a category “Real Estate” in a social media platform, the platform may provide a subcategory “3-room apartment,” however, the user typically cannot choose any deeper levels or more defined subcategories such as 2-bathrooms, 3-room apartment. Similarly, a user should be able to choose subcategories, such as “city” and many other features or subcategories, at the same time and in the same query.

### SUMMARY

This document describes user customizable subcategory definition for online content stores, as well as user customizable alerting for changes that occur to objects within the online content stores, particularly as those changes pertain to the defined subcategories.

In several aspect, a system, method and computer program product execute a computer-implemented process that includes generating a graphical user interface of a social media application for being rendered in an electronic display of a client computing system. The graphical user interface includes a set of graphical elements, each graphical element representing an object category or an object of the object category. The process further includes generating, in the graphical user interface, a user-selectable control feature associated with the object category, the user-selectable control feature providing a set of one or more sub-categories that a user can select to define one or more selected sub-categories of the object category.

The process further includes receiving, in the graphical user interface, input data to define the one or more selected sub-categories, and processing the input data to generate additional graphical elements representing the one or more selected sub-categories. The process further includes generating an updated graphical user interface of the social media application for being rendered in the electronic display of the client computing system, the updated graphical user interface comprising the set graphical elements and the additional graphical elements.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a graphical user interface of a social media application having a number of objects and alerts to selected objects;

FIG. 2 illustrates a user interface (UI) showing a number of elements that act as subcategories of a category;

FIG. 3 illustrates a graphical user interface that enables a user to define a new sub-category;

FIG. 4 illustrates a tree structure associated with a leaf-node definition in a social media platform.

FIG. 5 is a flowchart of a process executed by a system, method and computer program product.

When practical, similar reference numbers denote similar structures, features, or elements.

### DETAILED DESCRIPTION

To address the issues with currently available solutions, methods, systems, articles of manufacture, and the like, consistent with one or more implementations of the current subject matter can, among other possible advantages, provide a functionality to enable a user to propose a new category or subcategory that can be added to an objects structure of an online content store associated with a social media platform or social media application.

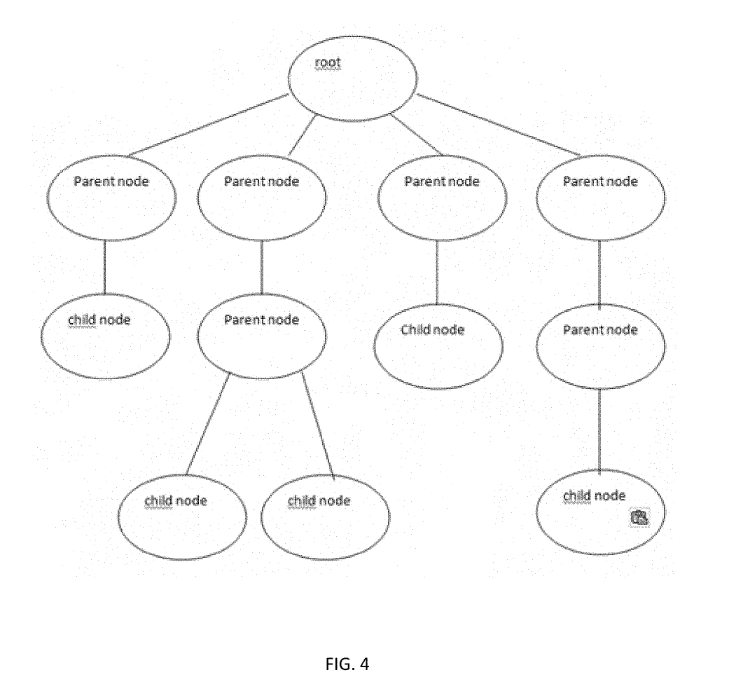

In some implementations, an alert object can be assigned by each user on any social media platform element, such as a folder, .doc, .xls, etc. Each object type on which the alert can be set will behave in a different way according to the alert type properties. For instance, an alert can be set at any of the following objects:
Folder: a user can set up the alert to get the notifications he is interested in, being able to choose (i.e., activate a checkbox in the UI) at the alert properties if he is interested in new objects (creation), modifications, deletions or any possible combination of all these options (e.g. Creation: No; Modifications: X; Deletions: X. In such a case he would receive the notifications about deletions and modifications only. Accordingly, the user will get notifications according to the alert properties established by the user, such as every time the folder was changed, created, deleted or modified, or if the folder itself was changed (e.g. the user changed the name of the folder). Or, further still, a user can receive an alert if a subfolder or subfolder social media platform element is created, deleted or modified, etc.
Leaf node (end node)—Refers to elements which cannot have sub-elements. The user will get notifications according to user-inputted preferences of the kinds of notifications he wants to receive: i.e. every time a file is created, deleted or modified, or every time the file content is modified
Group—The user can set in the alert properties which kind of notifications he wants to receive within the same group. The Group object is equivalent to the “root” node illustrated in FIG. 4 and described further below. This means a group will contain folders and leaf nodes. In the same way, if an alert is set at the root level, the user can choose if he is interested in creations, modifications, deletions or any combination of these options and get a notification every time any subnode changes accordingly. Every time someone joins a group, the default alert settings are applied at the group level.

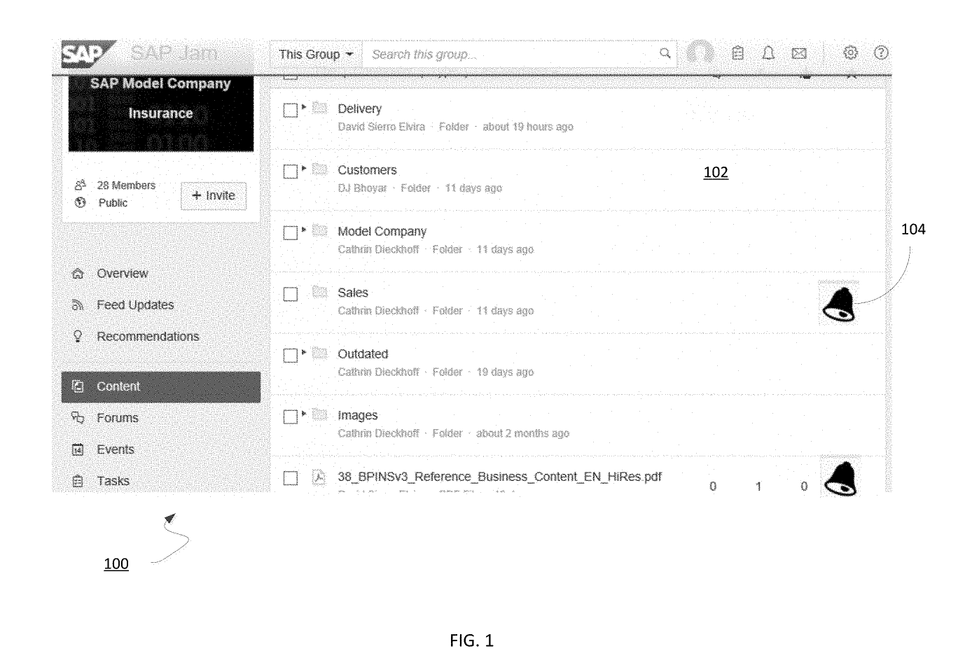

FIG. 1 illustrates a user interface (UI) 100, such as SAP's JAM Interface providing a number of elements 102 of various object types, such as folders, documents, PostScript Data Files (PDFs), etc., and including a function that allows a user to configure an alert that generates an alert icon 104 on each selected element 102. The alert icon 104 can include a hyperlink, by which the user can access further information about the alert, i.e. to gain more information in the UI 100 about an event or one or more conditions that trigger the alert, which in turn triggers the notification(s), for the selected object.

In other implementations, a functionality that enables a way for a user to propose a new category or subcategory, such as a graphical button representing “Propose new Category/Subcategory,” can be added to enhance the objects structure. Currently the subcategories do not provide much information about an object. According to these implementations, a user can propose, via interaction with the UI, new subcategories that do not already exist.

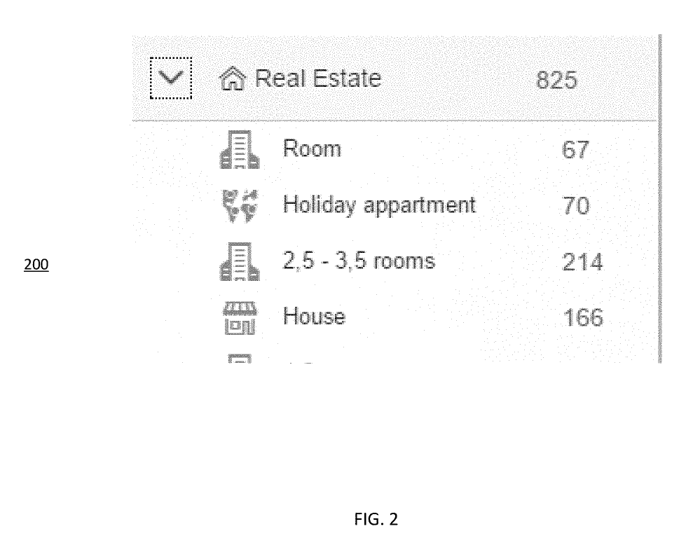

A user could propose a new category/subcategory just by clicking on a “New Category Proposal” button. For instance, for a real estate-oriented social media application, the user might be interested in apartments that have more than three rooms; however, the user might only be interested in those apartments that have at least two bathrooms. Therefore, as shown in FIG. 2, which illustrates a UI showing a number of elements that act as subcategories of a category, the system can allow the user to propose, via a UI 200, a new subcategory “Number of Bathrooms” that will contain several options, such as “1,” “2,” or “more than 3.” This proposal is sent by the system to a system manager, who can quickly check the details of the proposal, and release or reject the proposal as a workflow item.

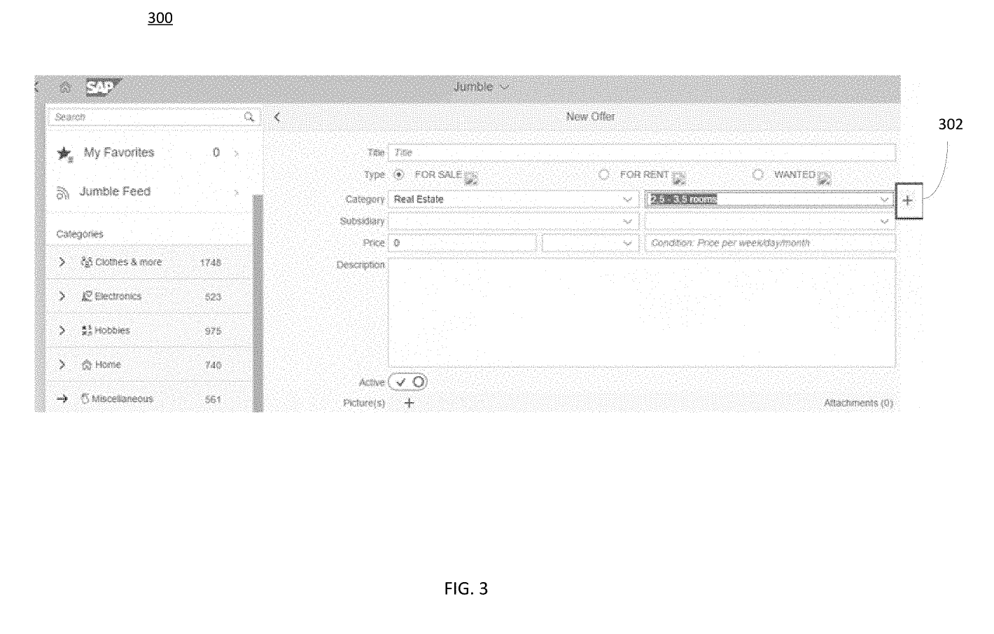

For such a purpose an Item and Search structure of the application is enhanced. Each object can have as many subcategories as desired. FIG. 3 illustrates a graphical user interface 300 that enables a user to define a new sub-category. As shown in FIG. 3, when creating the object, a button 302 that is added in the UI 300 can enable the user to add subcategories to which the object belongs.

Similarly, the search tool is enhanced in a hierarchical way. This means, at the proposal creation, any new subcategory can be assigned to one existing category/subcategory, thereby creating a search tree, as shown in FIG. 4, where every parent node can be extended by either a new parent node or a child node. Child/Leaf nodes are final nodes which cannot be extended.

Accordingly, the user that is interested in a very specific item need only set the search criteria once, and will automatically get the desired hits of a perfect match. To support this function, the system provides an option to save a search in a repository, for later access by the user if desired. On this search, the user or the system can set an alert which notifies the user every time a match is registered.

In some implementations, each time a user proposes a new subcategory via the application, the subcategory details are sent to the administrator who can decide whether the subcategory is applicable to the element category. If accepted, the subcategory is made available for all users anytime an object within the category is created, and the item can be assigned to several subcategories such as City, Bathrooms, Chimney, etc.

Accordingly, users will not need to spend much time reading texts that do not fit what they are looking for, because now most of the information appears in the description instead of the subcategories. By choosing existing subcategories, this avoids written errors that the search tool is not able to identify, and the tool is much more powerful. Further, administrator efforts are minimized, as most of the refinement in categorization, indexing and persistence is done by users.

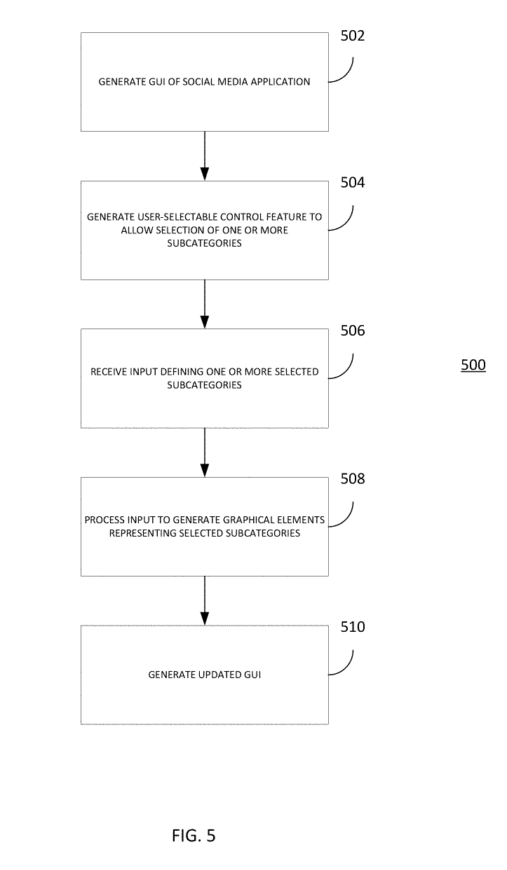

FIG. 5 is a flowchart of a process 500 executed by a system, method and computer program product. At 502, a graphical user interface of a social media application is generated for being rendered in an electronic display of a client computing system. The graphical user interface includes a set of graphical elements, each graphical element representing an object category or an object of the object category. At 504, a user-selectable control feature associated with the object category is generated in the graphical user interface, the user-selectable control feature providing a set of one or more sub-categories that a user can select to define one or more selected sub-categories of the object category.

At 506, input data to define the one or more selected sub-categories is received in the graphical user interface. At 508, the input data is processed to generate additional graphical elements representing the one or more selected sub-categories. At 510, an updated graphical user interface of the social media application is generated for being rendered in the electronic display of the client computing system, the updated graphical user interface including the set graphical elements and the additional graphical elements.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system comprising:
at least one programmable processor; and
a machine-readable medium storing instructions that, when executed by the at least one processor, cause the at least one programmable processor to perform operations comprising:
generating a graphical user interface of a social media application for being rendered in an electronic display of a client computing system, the graphical user interface comprising a set of graphical elements, each graphical element representing an object category or an object of the object category;
generating, in the graphical user interface, a user-selectable control feature associated with the object category, the user-selectable control feature providing a set of one or more sub-categories that a user can select to define one or more selected sub-categories of the object category;
receiving, in the graphical user interface, input data to define the one or more selected sub-categories;
processing the input data to generate additional graphical elements representing the one or more selected sub-categories; and
generating an updated graphical user interface of the social media application for being rendered in the electronic display of the client computing system, the updated graphical user interface comprising the set graphical elements and the additional graphical elements.

2. The system in accordance with claim 1, wherein the operations further comprise:
receiving, in the graphical user interface, input data to define an alert for a selected object, the alert defining an event related to the selected object.

3. The system in accordance with claim 2, wherein the operations further comprise:
generating, for rendering in the updated graphical user interface of the social media application, a graphical representation of the alert when the event occurs.

4. The system in accordance with claim 1, wherein the graphical representation of the alert includes a hyperlink.

5. A method comprising:
generating, by a computer processor, a graphical user interface of a social media application for being rendered in an electronic display of a client computing system, the graphical user interface comprising a set of graphical elements, each graphical element representing an object category or an object of the object category;
generating, by the computer processor in the graphical user interface, a user-selectable control feature associated with the object category, the user-selectable control feature providing a set of one or more sub-categories that a user can select to define one or more selected sub-categories of the object category;
receiving, by the computer processor via the graphical user interface, input data to define the one or more selected sub-categories;
processing, by the computer processor, the input data to generate additional graphical elements representing the one or more selected sub-categories; and
generating, by the computer processor, an updated graphical user interface of the social media application for being rendered in the electronic display of the client computing system, the updated graphical user interface comprising the set graphical elements and the additional graphical elements.

6. The method in accordance with claim 5, further comprising:
receiving, in the graphical user interface, input data to define an alert for a selected object, the alert defining an event related to the selected object.

7. The method in accordance with claim 6, wherein the operations further comprise:
generating, for rendering in the updated graphical user interface of the social media application, a graphical representation of the alert when the event occurs.

8. The method in accordance with claim 5, wherein the graphical representation of the alert includes a hyperlink.

9. A computer program product comprising a machine-readable medium storing instructions that, when executed by at least one programmable processor, cause the at least one programmable processor to perform operations comprising:
generate a graphical user interface of a social media application for being rendered in an electronic display of a client computing system, the graphical user interface comprising a set of graphical elements, each graphical element representing an object category or an object of the object category;
generate, in the graphical user interface, a user-selectable control feature associated with the object category, the user-selectable control feature providing a set of one or more sub-categories that a user can select to define one or more selected sub-categories of the object category;
receive, in the graphical user interface, input data to define the one or more selected sub-categories;
process the input data to generate additional graphical elements representing the one or more selected sub-categories; and
generate an updated graphical user interface of the social media application for being rendered in the electronic display of the client computing system, the updated graphical user interface comprising the set graphical elements and the additional graphical elements.

10. The computer program product in accordance with claim 9, wherein the operations further comprise:
receive, in the graphical user interface, input data to define an alert for a selected object, the alert defining an event related to the selected object.

11. The computer program product in accordance with claim 10, wherein the operations further comprise:
generate, for rendering in the updated graphical user interface of the social media application, a graphical representation of the alert when the event occurs.

12. The computer program product in accordance with claim 9, wherein the graphical representation of the alert includes a hyperlink.
